(19) United States
(12) Patent Application Publication
(10) Pub. No.: US 2015/0324821 A1
(43) Pub. Date: Nov. 12, 2015

(54) Multicultural Survey Response System

(71) Applicant: Rincon & Associates, Dallas, TX (US)

(72) Inventor: Edward T. Rincon, Dallas, TX (US)

(21) Appl. No.: 14/706,569

(22) Filed: May 7, 2015

Related U.S. Application Data
(60) Provisional application No. 61/989,622, filed on May 7, 2014.

(51) Int. Cl. G06Q 30/02

(52) U.S. Cl. CPC G06Q 30/0204

(57) ABSTRACT

The present invention includes a system and method for generating survey results, comprising: designing a survey in one or more languages that is offered to one or more survey participants in a format selected from at least one of hard copy, verbal, or online in the language of the survey participant; receiving, by a computer, a survey content from each of the survey participant, wherein each survey participant has a unique identification code for each survey; determining, by the computer, whether the survey content obtained from the survey participant regardless of the format in which the survey content is received, has already been obtained and if the survey content has been obtained rejecting the later entry as a duplicate; and generating, by the computer, a summary of the survey results obtained from the survey content.

### CROSS-REFERENCE TO RELATED APPLICATIONS

This application claims priority based on U.S. Provisional Application No. 61/989,622, filed May 7, 2014. The contents of which is incorporated by reference in its entirety.

### TECHNICAL FIELD OF THE INVENTION

The present invention relates in general to the field of surveys, and more particularly, to a multi-modal, multilingual multicultural survey response system.

### STATEMENT OF FEDERALLY FUNDED RESEARCH

None.

### BACKGROUND OF THE INVENTION

Without limiting the scope of the invention, its background is described in connection with surveys and marketing.

U.S. Pat. No. 8,712,824, issued to Julian, et al., is entitled “System and method for self service marketing research.” Briefly, this patent is said to teach a method and system for the creation, delivery, processing, and overall management of surveys across and on sites and applications that display online and mobile content that is tracked using an audience validation system. The patent is also said to teach improvements on the functionality of an audience validation system including creating a marketplace for content and application publishers to make their audiences available for general market research surveys. In one specific embodiment, the system is said to significantly reduce the overheads involved in market research for all parties concerned including publishers, the consumers of the publishers' content, and market researchers wishing to survey the consumers of the publishers' content. In another embodiment the invention is said to provide both publishers and marketers access to self-service portals to make their audiences available and to survey them respectively. Additional embodiments are said to include a number of optimizations that minimize survey fatigue among potential survey respondents and minimize the repetition of both surveys and individual questions being presented to individual users through the use of cached answers.

U.S. Pat. No. 8,346,593, issued to Fanelli, et al., is entitled “System, method, and software for prediction of attitudinal and message responsiveness.” Briefly, this patent is said to teach a system, a method, software and a data structure for independently predicting attitudinal and message responsiveness, using a plurality of attitudinal or other identification classifications and a plurality of message content or version classifications, for a selected population of a plurality of entities, such as individuals or households, represented in a data repository. The patent is also said to teach a plurality of predictive attitudinal (or identification) classifications and plurality of predictive message content classifications have been determined using a plurality of predictive models developed from a sample population and applied to a reference population represented in the data repository, such as attitudinal, behavioral, or demographic models. It is further stated that for each predictive attitudinal (or identification) classification, at least one predominant predictive message content or version classification is independently determined. Exemplary embodiments in the patent are said to also provide, for each predictive attitudinal classification, corresponding information concerning predominant communication media (or channel) types, predominant communication timing, predominant communication frequency, and predominant communication sequencing.

United States Patent Application Publication No. 2002/0063739, filed by Gosden, et al., is entitled “Iconographic medical and population survey and system and method for using the same.” Briefly, these applicants are said to teach a system for the collection of data about health problems, handicaps, water supplies, living conditions, and people at risk is disclosed. The application is said to teach a system using an iconographic, color-coded indicia to denote family members, dead children, major medical conditions, handicaps and treatments, and other data. Such iconographic, color-coded indicia are selectively positionable on an anonymous but individually coded survey form, from which a digital image is made and electronically transmitted to a searchable database storing a collection of such survey forms for purposes of providing ease of access to medical records and the development and implementation of palliative care, intervention, and prevention programs.

### SUMMARY OF THE INVENTION

In one embodiment the present invention includes a method for generating survey results, comprising: designing a survey in one or more languages that is offered to one or more survey participants in a format selected from at least one of hard copy, verbal, or online in the language of the survey participant; receiving, by a computer, survey content from each of the survey participant, wherein each survey participant has a unique identification code for each survey; determining, by the computer, whether the survey content obtained from the survey participant, regardless of the format in which the survey content is received, has already been obtained and, if the survey content has been obtained rejecting the later entry as a duplicate; and generating, by the computer, a summary of the survey results obtained from the survey content. In one aspect, the method further comprises designing a diagnostic evaluation prior to the survey to determine if the survey will achieve minimum thresholds for multi-language and multi-cultural participation; obtaining survey results from the survey; and if the survey does not achieve the minimum thresholds for multi-language and multi-cultural participation conducting one or more additional surveys until the diagnostic evaluation achieves the minimum thresholds for multi-language and multi-cultural participation. In another aspect, the diagnostic evaluation further comprises at least one of the following factors in the survey: defining a target audience that includes a profile of the target audience in terms of race-ethnicity, age, native or foreign-born, education, and household income; identifying in the target audience a method of self-identification, surname, birthplace, and assignment by the computer; evaluating a sampling frame or lists that include members of the target audience selected from at least one of household addresses, telephone lists, cellular phone lists, or Internet addresses based on parameters set in the computer; evaluating survey complexity by determining the time required to complete survey, simple or complex questions, sensitive questions, visual exhibits required, special knowledge required as determined by the computer; or determining if incentives will be necessary to engage the target audience for target audiences with known lower response rates. In another aspect, the method further comprises generating one or more surveys, and generating a list of prioritized questions based on the results of the diagnostic evaluation based on the preferred format of the survey participants based on at least one of their preferred format, cultural or linguistic profile. In another aspect, result of the diagnostic evaluation identifies potential barriers to implementation by using Census data (foreign-born, household income, education) to develop a survey participant profile that targets one or more multicultural communities. In another aspect, the diagnostic evaluation identifies low survey response rates for one or more demographic groups, and then using the computer to provide English only survey materials and interviewing for white and African American audiences, and bilingual surveys for Hispanic and Asian audiences to establish rapport, improves cooperation, enhance survey data quality, and expand demographic diversity of the respondents even if the overall survey response rate is low. In another aspect, the format of collection is selected from at least one of: mail, telephonic, online or in-person and the language for the survey is selected depending on the pre-determined profile for the survey participant regardless of whether the participant self-identifies for at least one of preferred format, language or culture. In another aspect, the survey participant self-identifies for at least one of preferred format, language or culture. In another aspect, an addressed-based household sampling method is used in the survey to maximize coverage of the survey participants of one or more demographic groups and subgroups. In another aspect, the method further comprises the step of removing from the survey at least one of outdated ethnic labels, words, or adding additional survey formats to survey taker expectations or biases toward a target survey participant demographic. In another aspect, the method further comprises selecting a rating scale that is commonly used by survey participants in a specific survey participant demographic. In another aspect, the method further comprises the step of maximizing survey participant responses for non-English speaking survey participation by at least one of: matching the language and culture of a survey taker to the language and culture of the survey participant, obtaining post-survey feedback from the survey participant about the language and culture of the survey taker, or identifying the everyday relevance of the translation used for the survey. In another aspect, the method further comprises the step of eliminating colors from mail, in-person, or online surveys that may be offensive to different cultural groups based on tradition or superstition. In another aspect, the method further comprises the step of checking the questionnaire for at least one of comprehension, ability to follow instructions, scale confusion, or offensive language. In another aspect, the method further comprises the step of sending survey to survey participants based on the target survey participant demographic and allowing more time for mailed survey responses to return that are not in English. In another aspect, the method further comprises correlating profile information with the survey responses, and presenting the survey responses with the correlated profile information.

In another embodiment, the present invention includes an apparatus, comprising: a server computer, having a processor and a memory coupled to the processor, the memory storing instructions which, when executed by the processor, cause the computer to perform the operations of: designing a survey in one or more languages that is offered to one or more survey participants in a format selected from at least one of hard copy, verbal, or online in the language of the survey participant; receiving, by a computer, a survey content from each of the survey participants, wherein each survey participant has a unique identification code for each survey; determining, by the computer, whether the survey content obtained from the survey participant regardless of the format in which the survey content is received, has already been obtained and if the survey content has been obtained rejecting the later entry as a duplicate; and generating, by the computer, a summary of the survey results obtained from the survey content. In one aspect, the apparatus further comprises the operations of: designing a diagnostic evaluation prior to the survey to determine if the survey will achieve minimum thresholds for multi-language and multi-cultural participation; obtaining survey results from the survey; and if the survey does not achieve the minimum thresholds for multi-language and multi-cultural participation conducting one or more additional surveys until the survey results achieve the minimum thresholds for multi-language and multi-cultural participation. In another aspect, the diagnostic evaluation further comprises at least one of the following factors in the survey: defining a target audience that includes a profile of the target audience in terms of race-ethnicity, age, native or foreign-born, education, and household income; identifying in the target audience a method of self-identification, surname, birthplace, and assignment by the computer; evaluating a sampling frame or lists that include members of the target audience selected from at least one of household addresses, telephone lists, cellular phone lists, or Internet addresses based on parameters set in the computer; evaluating survey complexity by determining the time required to complete survey, simple or complex questions, sensitive questions, visual exhibits required, special knowledge required as determined by the computer; or determining if incentives will be necessary to engage the target audience for target audiences with known lower response rates. In another aspect, the method further comprises generating one or more surveys, and generating a list of prioritized questions based on the results of the diagnostic evaluation based on the preferred format of the survey participants based on at least one of their preferred format, cultural or linguistic profile. In another aspect, result of the diagnostic evaluation identifies potential barriers to implementation by using Census data (foreign-born, household income, education) to develop a survey participant profile that targets one or more multicultural communities. In another aspect, the diagnostic evaluation identifies low survey response rates for one or more demographic groups, and then using the computer to provide English only survey materials and interviewing for white and African American audiences, and bilingual surveys for Hispanic and Asian audiences to establish rapport, improves cooperation, enhance survey data quality, and expand demographic diversity of the respondents even if the overall survey response rate is low. In another aspect, the format of collection is selected from at least one of mail, telephonic, online or in-person and the language for the survey is selected depending on the pre-determined profile for the survey participant regardless of whether the participant self-identifies for at least one of preferred format, language or culture. In another aspect, the survey participant self-identifies for at least one of preferred format, language or culture. In another aspect, an addressed-based household sampling method is used in the survey to maximize coverage of the survey participants of one or more demographic groups and subgroups. In another aspect, the method further comprises the step of removing from the survey at least one of outdated ethnic labels, words, or adding additional survey formats to survey taker expectations or biases toward a target survey participant demographic. In another aspect, the method further comprises selecting a rating scale that is commonly used by survey participants in a specific survey participant demographic. In another aspect, the method further comprises the step of maximizing survey participant responses for non-English speaking survey participation by at least one of: matching the language and culture of a survey taker to the language and culture of the survey participant, obtaining post-survey feedback from the survey participant about the language and culture of the survey taker, or identifying the everyday relevance of the translation used for the survey. In another aspect, the method further comprises the step of eliminating colors from mail, in-person, or online surveys that may be offensive to different cultural groups based on tradition or superstition. In another aspect, the method further comprises the step of checking the questionnaire for at least one of comprehension, ability to follow instructions, scale confusion, or offensive language. In another aspect, the method further comprises the step of sending survey to survey participants based on the target survey participant demographic and allowing more time for mailed survey responses to return that are not in English. In another aspect, the method further comprises correlating profile information with the survey responses, and presenting the survey responses with the correlated profile information.

### BRIEF DESCRIPTION OF THE DRAWINGS

For a more complete understanding of the features and advantages of the present invention, reference is now made to the detailed description of the invention along with the accompanying figures and in which:

FIG. 1 shows a basic outline of the features of the present system.

FIG. 2 shows a basic outline of the research design of the present system.

FIG. 3 shows the basic outline of the sampling plan.

FIG. 4 shows aspects of the survey instruments that can be input and managed with the system.

FIG. 5 shows the basic outline of a data collection plan for use and input into the system of the present invention.

FIG. 6 shows the basic outline of the corporate resources that can be tracked, scheduled, input, validated, and/or organized by the system of the present invention.

FIG. 7 shows the basic outline of the implementation phase of the system of the present invention.

FIG. 8 shows the basic outline of the outcomes and benefits generated by and from the present invention.

FIG. 9 shows additional detail for the overall survey information system.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As the United States (and other countries) have become more multi-ethnic and multi-cultural, traditional survey practices have failed to provide the types of survey options that allow employers, industry, and government (among others) to seek and obtain survey results that accurately reflect the wants and needs of the survey participants. Thus, there is a need to change traditional research practices. For example, when it comes to English-only surveys, Respondents are usually provided only one language option to complete a survey—English—which excludes people who cannot read, write or speak English very well from participating in a survey. Single-Mode Surveys have the problem that Only one mode of data collection is usually offered to survey respondents—in-person, telephone, mail or online—which prevents many people from completing a survey because they lack reading or writing skills, have hearing or visual disabilities, lack of access to the Internet, or simply do not have a telephone.

It is known that sample bias is a continuing problem. For example, Latino, Asian and African American respondents are often selected by surname methods or by concentrating on zip codes where they reside in high concentrations—practices that produce biased samples of respondents that do not represent their respective communities. Another problem is improper ethnic classification. The common practice of using outdated, irrelevant or offensive labels to identify multicultural persons leads to lower survey response rates as well as the misclassification of racial-ethnic persons. Often surveys also include irrelevant content. For example, surveys often include questions or scales that are not relevant to the experiences of culturally-defined groups, especially if their residency in the U.S. is brief, which undermines the validity of the information collected. Additional problems are created by the common usage of predictive dialers. The use of predictive dialers—automated telephone programs that rapidly dial thousands of phone numbers in a short period of time—may reduce interviewing costs but decreases the chances of completing an interview with households that are not available during these brief periods. Finally, current survey practitioners often lack the needed cultural IQ. Research practitioners often lack the academic training and culturally-relevant experiences to adapt their practices to multicultural communities and not always conscious of the errors that they are making.

The long-term consequences of improper surveys practices contribute to biases that can dramatically alter the quality of a survey and its representativeness, especially in communities that are linguistically and culturally diverse. In the long term, such studies lead to: (1) exclusion or under-representation of multicultural persons from surveys; (2) less valid information about the knowledge, attitudes and behavior of multicultural persons; and (3) incorrect decisions about the effectiveness of advertising campaigns or other programs that target multicultural persons. To avoid these problems, a unique multicultural survey response system was developed that departs from traditional practices to improve survey quality and outcomes.

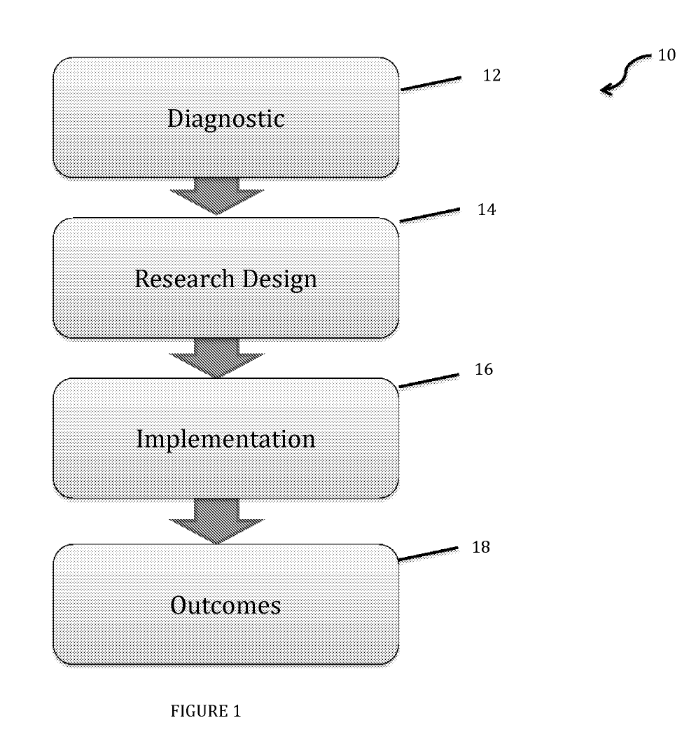

FIG. 1 shows a basic outline of the features of the present system 10. In step 12, a diagnostic evaluation or equivalent is conducted to reduce the financial risks resulting from implementation of a poorly study design, to identify potential problems in the proposed study objectives, methodology, target audience and expected outcomes. In step 14 (Research/Design), a research design and budget that will meet the study objectives for the target audience and remove or minimize potential threats to achievement of these objectives. In step 16 (Implementation), the recommended study design using multicultural insights, specialized software, state-of-the-art research facility, and multicultural interviewing staff is used. Finally, in step 18 (Outcomes), the requested project deliverables are provided and a meeting with stakeholders to discuss the study findings and conclusions may be held.

In the diagnostic evaluation, one or more of the following are developed, confirmed, and/or entered into the database: (1) Target audience: develop profile of the target audience in terms of race-ethnicity, age, native vs. foreign-born, education, and household income; (2) Identifying the target audience: choose a method like self-identification, surname, birthplace, assignment by special software; (3) Evaluate sampling frame/lists: which lists can best reach members of the target audience—household addresses, telephone lists, cellular phone lists, Internet addresses, etc.; (4) Evaluate survey complexity: time required to complete survey, simple or complex questions, sensitive questions, visual exhibits required, special knowledge required; and/or (5) Engagement Challenges: captive audiences (employees, members of organizations) may not require incentives, but incentives may be needed for target audiences with known lower response rates.

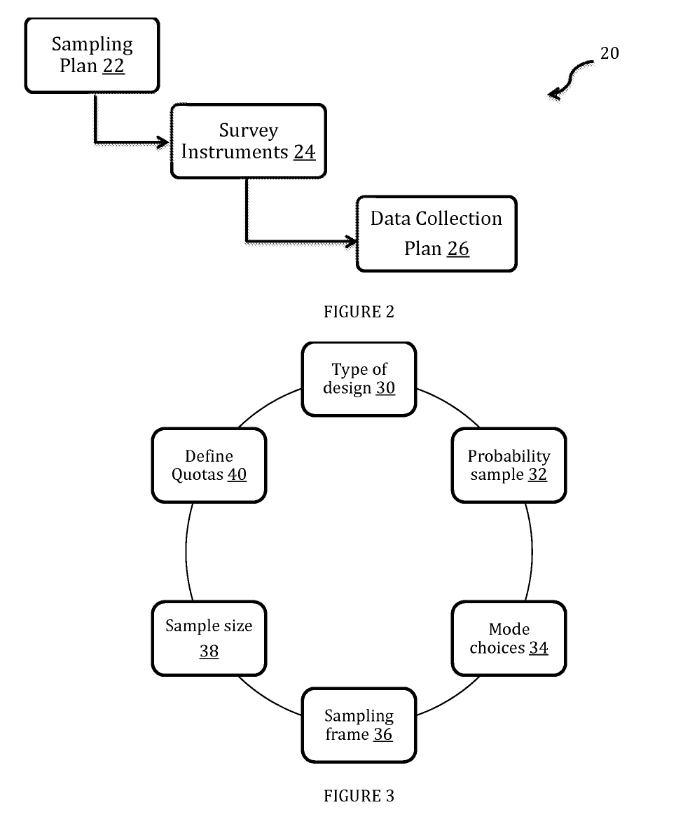

The basic outline of the research design 20 is shown in FIG. 2. Briefly, and as explained in greater detail hereinbelow, a sampling plan 22 is developed and input into the system. Based on that sampling plan 22, the survey instruments 24 are developed and input into the system. Finally, a data collection plan 26 is programmed.

FIG. 3 shows the basic outline of the sampling plan, which includes types of designs 30, probability sample 32, mode choices 34, sampling frame 36, sample size 38, and/or quotas defined 40. These parameters can also be input into the system for validation of final results.

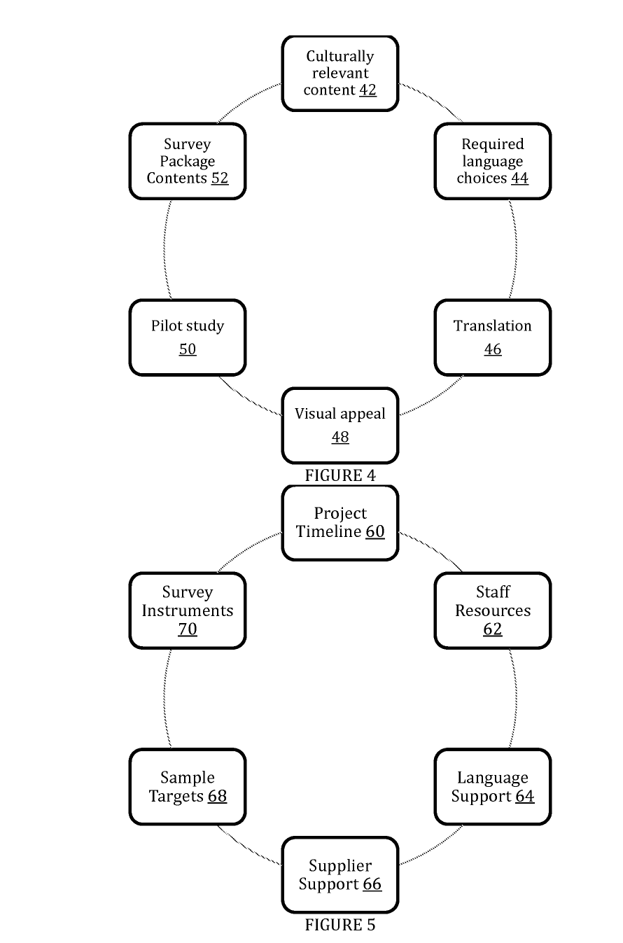

FIG. 4 shows various inputs into the system for the survey instruments, including culturally relevant content 42, required language choices 44, translation 46, visual appeal 48, pilot study 50, and/or survey package contents 52.

FIG. 5 shows the basic outline of a data collection plan for use and input into the system of the present invention, that includes, e.g., a project timeline 60, an allocation of staff resources 62, language support 64, supplier support 66, sample targets 68, and/or the survey instrument 70. All of these can include scheduling modules, verification that the language of the survey taker matches that of the survey participant (and/or cultural competence within a language).

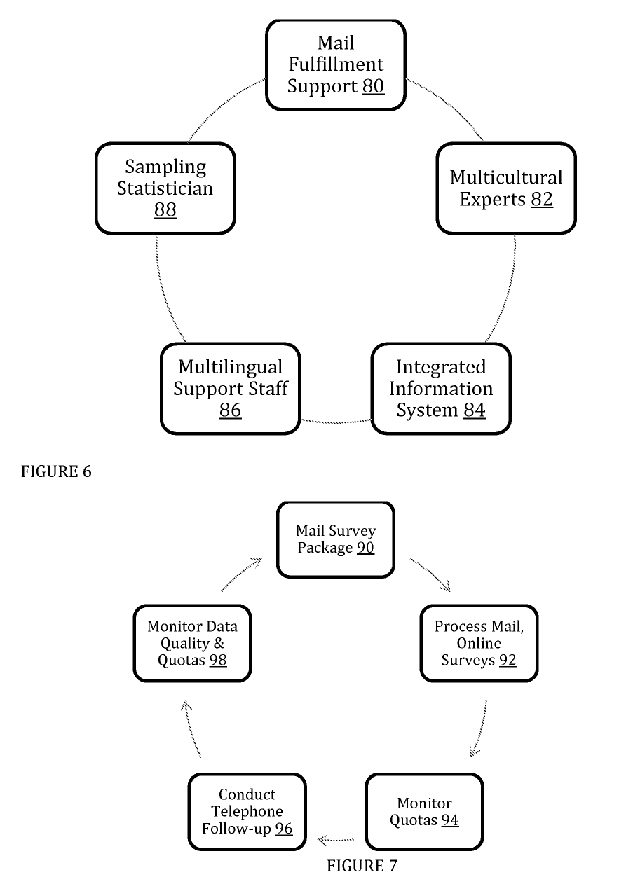

FIG. 6 shows the basic outline of the corporate resources that can be tracked, scheduled, input, validated, and/or organized by the system of the present invention. These can include: mail support and fulfillment 80, scheduling and use of multicultural experts 82, integrated information system 84, multicultural support staff 86, and/or statistical sampling 88 and verification and/or inputs.

FIG. 7 shows the basic outline of the implementation phase of the system of the present invention. The system can generate, among others, the mail survey package 90, process mail and online surveys 92, monitor quotas 94, generate a list for conducting follow-up interviews 96, and/or monitor data quality and quotas 98.

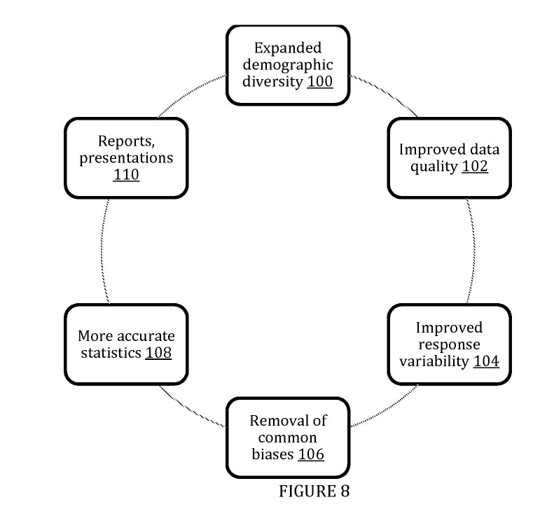

FIG. 8 shows the basic outline of the outcomes and benefits generated by and from the present invention. These include, e.g., expanded demographic diversity 100, improved data quality 102, improved response variability 104, removal of common biases 106, generate more accurate statistics 108, and generate data and/or reports and presentation 110.

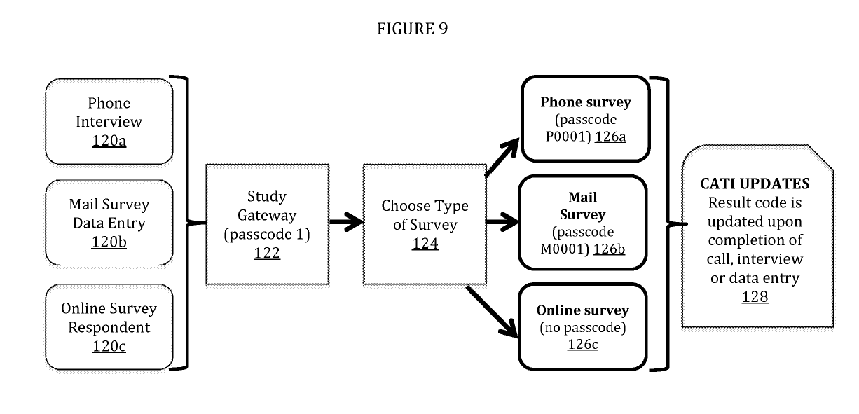

FIG. 9 shows additional detail for the overall survey information system. The MMML Survey Information System provides multiple points of entry 120a, 120b, 120c, for the completion of surveys by respondents in multiple languages and modes in a secure computing environment that prevents entry by unqualified persons without the appropriate passcodes (2 levels). At the study gateway 122 a first passcode is entered, and then a type of survey gateway 124 is selected. The system guards against multiple entries by the same respondent and threats to data integrity based on additional passcode verification at 126a, 126b, or 126c, and the system updates 128 in which the resulting code is updated.

The following describes the differences between the present invention and traditional survey practices, including traditional multi-mode practices. The present invention may include one or more of these advantages as part of the present invention. Seven primary areas of distinction are provided: Diagnostic; Research Design; Identification of Ethnic Persons; Sample Design; Questionnaire Design Data Collection; and Outcomes/Benefits. The area of Questionnaire Design can include one or more of the following subsections: A. General Question Design; B. Rating Scales; C. Language; D. Visual Appeal; E. Pilot Study; and/or F. Mail Survey Package Contents. The area of Data Collection can include one or more of the following subsections: A. Project Timeline; B. Survey Information System To Process Surveys; C. Staffing; and/or D. Predictive Dialers.

I. Area

1. Diagnostic Evaluation of Background Information.

The present invention includes a diagnostic evaluation of a proposed survey design or methodology to evaluate potential problems or challenges that might be encountered with the target audience, which is essential to avoid problems in implementation and possible financial losses. Each of the sections below compares and contrasts: (a) the traditional survey practices of the industry; (b) more detailed multi-mode practices; and (c) the practices and advantages of the system and methods of the present invention.

Traditional Survey Practices. Traditional research practitioners often fail to take this initial diagnostic step, which involves an analysis of target audience characteristics like language usage; reading, writing or speaking preferences; cultural values; and access to a computer, telephone or the Internet.

Mixed-Mode Study Practices. Similar to traditional practices, although greater efforts are made to remove barriers that influence specific modes of data collection. Most mixed-mode studies, however, show little concern for language or cultural barriers to survey participation.

The MMML (multi-modal, multilingual) approach of the present invention uses an in-depth diagnostic evaluation of the client's proposed methodology, if provided, to identify potential barriers to implementation. Current Census data (i.e., foreign-born, household income, education) is used to profile the needs of the target community and can be input into the system. If the client does not provide a proposed methodology, the evaluation focuses on potential challenges in reaching the desired target audience. The present inventor has found that a demographic analysis offers precise recommendations for ensuring a successful survey experience in diverse communities.

II. Research Design

1. Language Choices.

Traditional Survey Practices. English is the usual language provided by research practitioners in the U.S., while non-English languages are more likely to be provided in studies sponsored by public agencies. English-only surveys often exclude significant numbers of respondents that do not communicate in English very well such as immigrants and under-educated segments of the population.

Mixed-Mode Study Practices. Similar to traditional practices, but little attention is given to the potential benefits of providing language choices other than English.

The MMML (multi-modal, multilingual) approach of the present invention uses, e.g., the diagnostic evaluation which identifies the specific languages that will be required to capture the survey responses of key demographic groups. Generally, English-only survey materials and interviewing for white and African American audiences are recommended, while bilingual support for Hispanic and Asian audiences is recommended. The expanded language choices help to establish rapport, improves cooperation, and enhances survey data quality and expands the demographic diversity of the respondents even when the overall survey response rate is low.

2. Mode Choices.

Traditional Survey Practices. Typically only one mode of data collection is offered to survey respondents—either in-person, telephone, mail or online; This practice excludes persons from participating in a survey because they lack access to a phone or the Internet, or may have a physical disability that limits their hearing or speaking abilities.

Mixed-Mode Study Practices. More than one mode is offered to complete a survey to provide greater access, but traditional mixed-mode practitioners typically use only one language.

The MMML approach of the present invention uses the diagnostic evaluation to identify the modes of data collection that will best fit the needs of the target audience, which usually includes a mail survey, an online survey, and a telephone interview—although other modes may be used as needed. Importantly, the MMML method ensures that each of these modes is also supported in English and each of the non-English languages commonly used by members of the target audience. The MMML method removes common barriers to survey participation.

3. Identification of Ethnic Persons.

Traditional Survey Practices. Listings of respondents often lack an assigned race-ethnic label or code. When absent, race-ethnicity is inferred by surname only, birthplace, language spoken, or visual appearance. Existing race-ethnic labels may be outdated or offensive and lead to inconsistencies and errors in classification.

Mixed-Mode Study Practices. Similar to Traditional Practices.

The MMML approach of the present invention uses the self-identification by respondents (preferred); and if not available, a likely race-ethnic classification is assigned based on first and last name, and geographic residence—with 80-90% accuracy. This step allows for more precise determination of the language needs for the survey and minimize classification errors when race-ethnic information is not provided or available, and for continued tracking by the system.

4. Sample Design.

Traditional Survey Practices. With the exception of some national survey organizations, many general practitioners do not employ a sampling expert to develop a sampling plan that guides the selection of survey respondents in a scientific manner using probability sampling. Surveys mailed to households provide the best coverage but at a higher cost, which is why the more common approaches have been telephone and online surveys. Telephone samples, however, often exclude households without a listed telephone as well as low-income, minority households who often use cell phones. Similarly, online surveys use Internet panels of people that are paid to complete surveys, often excluding low-income minorities & persons without online access. Due to their lack of training and cultural intelligence, many research practitioners are indifferent to or unaware of these biases. Sampling problems produce errors in statistical estimates, especially for multicultural populations.

Mixed-Mode Study Practices. Similar to traditional practitioners. A mixed-mode study may select different samples of respondents from different sources, and combine the collected data—not necessarily meeting the standard of a probability sample from one population.

The MMML approach of the present invention uses the sampling plan required for an MMML study which is more complex and requires the involvement of a sampling expert to minimize common sampling biases. Regardless of the specific selection method used by or input into the system (i.e., simple random sample, systematic, stratified, cluster, etc.) the sampling frame in an MMML study can include a listing of all household addresses in the designated geographic area to ensure nearly 100% access to the target audience. Unlike a telephone or online panel sample, the addressed-based household sampling used in an MMML study offers the best coverage of the target audience and ensures the inclusion of a broader diversity of demographic subgroups. Coverage or frame errors are minimized by the MMML method, which improves the representation of the study sample.

5. Questionnaire Design.

a. General Question Design.

Traditional Survey Practices. Generally focus on designing questions that are assumed to be universally understood by all potential respondents. Pilot testing of the questionnaire is not a consistent practice.

Mixed-Mode Study Practices. Similar to Traditional Practitioners.

The MMML approach of the present invention uses a questionnaire that is designed and input into the system that thoroughly evaluates and identifies question wording and formats that may be problematic, such as outdated ethnic labels, or behaviors that are more common in mainstream than ethnic communities. A pilot test is often strongly recommended.

b. Rating Scales.

Traditional Survey Practices. Common scale formats are assumed to be universally understood, but such scales can create confusion, increase missing responses, and lead to response sets with ethnic respondents—all problems that undermine the quality of the survey data.

Mixed-Mode Study Practices. Similar to Traditional Practitioners.

In the MMML approach great care is exercised in rating scales that are included in a survey. Rather than translate a scale, a new scale can be created and input into the system in the non-English language that is conceptually equivalent. In some cultures, the use of numeric scales is more easily understood than scales with verbal anchors or labels. The goal is to obtain a valid response to questions in all languages by avoiding simple literal translations and ensuring conceptual equivalence across different cultures.

c. Language.

Traditional Survey Practices. The traditional U.S. practice is to conduct surveys only in English, while some practitioners offer a Spanish-language survey or interview only upon request by the respondent—a practice that discourages non-English speakers from participating in the survey. In addition, when a survey is translated into a non-English language, the quality of the translation is often of poor quality and not pilot tested with the relevant audiences. Poor response rates, missing data, and incoherent responses often result from such practices.

Mixed-Mode Study Practices. Similar to Traditional Practitioners.

The MMML approach of the present invention uses three steps to ensure the integrity of the languages used in a survey. (a) Matching of translator: it is generally preferred to use certified translators as a starting point to translate a survey, preferably one whose cultural origin is similar to the target audience, (b) Interviewer Feedback: proportionally a greater value is input into the system for feedback received by interviewers to check on the everyday relevance of the translation, (c) Pilot Study: the final proof of the results is based on the results of the pilot study with members of the target audience, which often identifies problems missed by the other steps.

d. Visual Appeal.

Traditional Survey Practices. The visual appeal of a questionnaire, especially for mail and online surveys, varies considerably and significantly influences the respondent's engagement and ability to record their responses accurately. While large national survey organizations make the effort to design visually appealing surveys, it is done inconsistently by many research practitioners.

Mixed-Mode Study Practices. Similar to Traditional Practitioners.

The MMML approach of the present invention transmits or sends a mail survey; that is input into the system, to all of the selected households, and its visual appeal is critical to engage respondents. All of the materials included in the initial mail survey package are designed and typeset by our graphics designer, while the digital files are provided to the fulfillment house for printing, merging, postage metering, and delivery to the post office. A specially designed phrase is also printed outside of the out-bound envelope, in the relevant languages, to visually engage the respondent and increase the likelihood of opening the envelope. If an incentive or sweepstakes is offered, a relevant alert is also added to the out-bound envelope. Generally, it is a best practice to avoid using colors that may be offensive to different cultural groups based on tradition or superstition, which can be input into the system for validation and prohibition when input from those communities is sought.

e. Pilot Study.

Traditional Survey Practices. Always recommended to identify potential problems before study implementation, but infrequently done.

Mixed-Mode Study Practices. Similar to Traditional Practitioners.

The MMML approach of the present invention uses a questionnaire that is translated into different languages, and a pilot study is conducted with members of the target audience in all relevant languages to check the questionnaire for comprehension, ability to follow instructions, scale confusion, and offensive language and the results can be input into the system. Once all of the needed changes to the questionnaire are made based on the pilot study results, the questionnaire is ready to be programmed into the system. Budget permitting, one or more focus groups are conducted with members of the target audience to visually observe them while completing a questionnaire and identifying (by red circles) the words, phrases or scales that are confusing or problematic.

f. Mail Survey Package Contents.

Traditional Survey Practices. Studies that use only a mail survey method generally include English-only documents, such as a cover letter, printed survey, and a postage-paid envelope. Not surprisingly, response rates to mail surveys are often lower than other modes, a consequence of using only one language, not including an incentive, and being visually unappealing.

Mixed-Mode Study Practices. Similar to traditional practitioners, although more efforts are devoted to giving survey respondents more than one mode to complete a survey.

The MMML approach of the present invention uses a mail survey package that includes the bounded survey booklet and a postage paid business reply envelope. Importantly, an English-language survey is included for white and African American households, while Hispanic and Asian households are provided both an English and a non-English language survey—a key step that significantly improves response rates in some markets, and the input and results are tracked by the system. The first page of the survey booklet is often a cover letter that includes key information: Unique ID and password, a link to an online version of the survey, a toll-free number to call for help in different languages or for completing a survey, and an explanation of an incentive or sweepstakes offer.

6. Data Collection.

a. Project Timeline.

Traditional Survey Practices. Most research practitioners include a project timeline to guide the implementation of their data collection activities. Since most survey research studies employ one mode and one language, the project timeline may be less complex and easier to manage.

Mixed-Mode Study Practices. Similar to traditional research, but a project timeline can become more complex with the addition of two or more modes of data collection.

Due to its increased complexity, the MMML approach of the present invention uses a project timeline for an MMML study that requires considerably more input to ensure that all of the required tasks are conducted in a carefully designed sequence. The timeline input into the system for delivery of the initial mail survey package varies by the extent of the geographic coverage (local vs. national) and the type of postage used (standard vs. first class). Once delivered, additional time is input into the system (generally about 2-6 weeks) are dedicated to allow the processing of completed mail and online surveys. Once the volume of mail and online surveys diminishes, out-bound telephone calls are initiated by telephone interviewers to the non-respondents with a telephone number. The data collection is completed when it is determined that the total number of surveys and the quotas defined by the sampling plan are achieved.

b. Survey Information System to Process Surveys.

Traditional Survey Practices. Since traditional practitioners typically conduct surveys in only one language and one mode (telephone, mail, online, etc.), the survey information system that is required is not very complex. However, a more specialized survey information system is required to process surveys that are inputted from multiple sources (mail, telephone, online) and in several languages. In addition, a specialized security system is required to prevent a respondent from submitting a survey more than once, and blocking access from uninvited persons.

Mixed-Mode Study Practices. Mixed-mode studies require an information system that can accommodate multiple modes and some level of security. However, most mixed-mode studies are not concerned with providing more than one language option, and do not allow the integration of all sources of survey input into one integrated system.

The MMML approach of the present invention uses a single integrated survey information system that supports all of the requirements of an MMML study, including the ability to process surveys simultaneously from multiple modes and multiple languages, and a unique identification and password system to allow secured access to the survey. The system can generate daily progress reports and manage complex quotas to ensure that the sample design specifications are met. The quota management system further allows identification of shortages in particular quota cells that can generate schedules and contact information for additional follow-up calls by telephone interviewers.

c. Staffing.

Traditional Survey Practices. General research shops tend to employ staff that understand general survey audiences, but typically lack the training and experience to conduct research with linguistically and culturally-diverse audiences. Rather than employ the staff that they need, such firms often limit their survey audiences only to those that can communicate in English, or simply out-source any non-English language survey work to companies in foreign countries that may not know U.S. geography, institutions, brand names and other important information.

Mixed-Mode Study Practices. Similar to General Practitioners.

The MMML approach of the present invention uses, by design, multicultural, multilingual staffing for all stages of a MMML survey project. The project leader is trained and experienced in the design and execution of multicultural studies and use of the system. All interviewing, data entry, and supervising staff are proficient in English and a second language (i.e., English, Spanish, Chinese, Korean, Vietnamese, etc.) that can be scheduled and validated by the system. All statistical analysis, report writing and presentations can be generated by the system for review by in-house staff or the client. Key research staff have doctorates in their respective fields and have published extensively.

d. Predictive Dialers.

Traditional Survey Practices. Predictive dialers automatically call thousands of telephone numbers in a short period of time, which cuts down on interviewer labor costs. This equipment, however, introduces a brief silence in the initial phone call that causes respondents to hang up, and covers narrow periods of time that causes many respondents to be missed that might otherwise be available to conduct the interview. Predictive dialers may also raise costs because they require thousands of telephone numbers in order to be effective during these short time periods.

Mixed-Mode Study Practices. Similar to traditional practitioners, although the negative consequences of using predictive dialers may be minimized when other modes of data collection aside from telephone are offered to survey respondents.

Because their disadvantages outweigh their advantages, under the MMML approach of the present invention predictive dialers are never used in the telephone follow-up portion of an MMML study. The system can generate reports and a schedule for telephone follow-up calls over a period of several weeks during mornings, afternoons, and evenings. Generally, telephone calls are initiated by telephone interviewers, not machines.

7. Outcomes/Benefits of the Present Invention.

Demographic diversity. Compared to traditional research practices, the expanded options provided by MMML studies produce a greater diversity of respondents by race-ethnicity, language, income, age, and education. The removal of offensive or culturally irrelevant words, phrases or concepts also improves survey participation.

Missing responses. Fewer missing values are observed in MMML studies since offensive language is minimized and respondents choose the mode and language that fits their comfort and comprehension levels for completing a survey.

Response variability. Better response variability is observed in MMML studies because respondents are better able to comprehend the questions and response options, which minimizes response sets.

Race-ethnic data. Race-ethnic information is more complete because the MMML method utilizes updated race-ethnic labels that are more contemporary and less offensive. Ethnic labels like Hispanic, Latino, and Asian are also defined by providing the names of countries that these labels represent.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the apparatus, system and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

None.

What is claimed is:

1. A method for generating survey results, comprising:
designing a survey in one or more languages that is offered to one or more survey participants in a format selected from at least one of hard copy, verbal, or online in the language of the survey participant;
receiving, by a computer, a survey content from each of the survey participant, wherein each survey participant has a unique identification code for each survey;
determining, by the computer, whether the survey content obtained from the survey participant regardless of the format in which the survey content is received, has already been obtained and if the survey content has been obtained rejecting the later entry as a duplicate; and
generating, by the computer, a summary of the survey results obtained from the survey content.

2. The method of claim 1, further comprises designing a diagnostic evaluation prior to the survey to determine if the survey will achieve minimum thresholds for multi-language and multi-cultural participation;
obtaining survey results from the diagnostic evaluation or survey; and
if the survey does not achieve the minimum thresholds for multi-language and multi-cultural participation conducting one or more additional follow-up surveys until the survey achieves the minimum thresholds for multi-language and multi-cultural participation.

3. The method of claim 2, wherein the diagnostic evaluation further comprises at least one of the following factors in the survey:
defining a target audience that includes a profile of the target audience in terms of race-ethnicity, age, native or foreign-born, education, and household income;
identifying in the target audience a method of self-identification, surname, birthplace, and assignment by the computer;
evaluating a sampling frame or lists that include members of the target audience selected from at least one of household addresses, telephone lists, cellular phone lists, or Internet addresses based on parameters set in the computer;
evaluating survey complexity by determining the time required to complete survey, simple or complex questions, sensitive questions, visual exhibits required, special knowledge required as determined by the computer; or
determining if incentives will be necessary to engage the target audience for target audiences with known lower response rates.

4. The method of claim 2, further comprising at least one of:
generating one or more surveys, comprising generating a list of prioritized questions based on the results of the diagnostic evaluation based on the preferred format of the survey participants based on at least one of their preferred format, cultural or linguistic profile;
developing a survey participant profile that targets one or more multicultural communities, wherein the result of the diagnostic evaluation identifies potential barriers to implementation by using Census data (foreign-born, household income, education); or
using the computer to provide English only survey materials and interviewing for white and African American audiences, and bilingual surveys for Hispanic and Asian audiences, when the diagnostic evaluation identifies low survey response rates for one or more demographic groups, and then to establish rapport, improves cooperation, enhance survey data quality, and expand demographic diversity of the respondents even if the overall survey response rate is low.

5. The method of claim 1, wherein at least one of:
the format of collection is selected from at least one of mail, telephonic, online or in-person and the language for the survey is selected depending on the pre-determined profile for the survey participant regardless of whether the participant self-identifies for at least one of preferred format, language or culture;
the survey participant self-identifies for at least one of preferred format, language or culture; or
an addressed-based household sampling method is used in the survey to maximize coverage of the survey participants of one or more demographic groups and subgroups.

6. The method of claim 1, further comprising at least one of:
the step of removing from the survey at least one of outdated ethnic labels, words, or adding additional survey formats to survey taker expectations or biases toward a target survey participant demographic; or
selecting a rating scale that is commonly used by survey participants in a specific survey participant demographic.

7. The method of claim 1, further comprising at least one of:
the step of maximizing survey participant responses for non-English speaking survey participation by at least one of: matching the language and culture of a survey taker to the language and culture of the survey participant, obtaining post-survey feedback from the survey participant about the language and culture of the survey taker, or identifying the everyday relevance of the translation used for the survey;
eliminating colors from mail, in-person, or online surveys that may be offensive to different cultural groups based on tradition or superstition;
checking the questionnaire for at least one of comprehension, ability to follow instructions, scale confusion, or offensive language; or
sending survey to survey participants based on the target survey participant demographic and allowing more time for mailed survey responses to return that are not in English; or correlating profile information with the survey responses, and presenting the survey responses with the correlated profile information.

8. An apparatus, comprising: a server computer, having a processor and a memory coupled to the processor, the memory storing instructions which, when executed by the processor, cause the computer to perform the operations of:
designing a survey in one or more languages that is offered to one or more survey participants in a format selected from at least one of hard copy, verbal, or online in the language of the survey participant;
receiving, by a computer, a survey content from each of the survey participant, wherein each survey participant has a unique identification code for each survey;
determining, by the computer, whether the survey content obtained from the survey participant regardless of the format in which the survey content is received, has already been obtained and if the survey content has been obtained rejecting the later entry as a duplicate; and
generating, by the computer, a summary of the survey results obtained from the survey content.

9. The apparatus of claim 8, further comprising the operations of:
designing a diagnostic evaluation prior to the survey to determine if the survey will achieve minimum thresholds for multi-language and multi-cultural participation;
obtaining survey results from the diagnostic survey; and
if the survey does not achieve the minimum thresholds for multi-language and multi-cultural participation conducting one or more additional surveys until the survey achieves the minimum thresholds for multi-language and multi-cultural participation.

10. The apparatus of claim 8, wherein the diagnostic evaluation further comprises at least one of the following factors in the survey:
defining a target audience that includes a profile of the target audience in terms of race-ethnicity, age, native or foreign-born, education, and household income;
identifying in the target audience a method of self-identification, surname, birthplace, and assignment by the computer;
evaluating a sampling frame or lists that include members of the target audience selected from at least one of household addresses, telephone lists, cellular phone lists, or Internet addresses based on parameters set in the computer;
evaluating survey complexity by determining the time required to complete survey, simple or complex questions, sensitive questions, visual exhibits required, special knowledge required as determined by the computer; or
determining if incentives will be necessary to engage the target audience for target audiences with known lower response rates.

11. The apparatus of claim 8, wherein the memory stores further instructions for generating one or more surveys, comprising generating a list of prioritized questions based on the results of the diagnostic evaluation based on the preferred format of the survey participants based on at least one of their preferred format, cultural or linguistic profile.

12. The apparatus of claim 8, further comprising the step of identifying barriers to implementation by using Census data (foreign-born, household income, education) to develop a survey participant profile that targets one or more multicultural communities as a result of the diagnostic evaluation.

13. The apparatus of claim 8, wherein the memory stores further instructions for identifying low survey response rates for one or more demographic groups, and then using the computer to provide English only survey materials and interviewing for white and African American audiences, and bilingual surveys for Hispanic and Asian audiences to establish rapport, improves cooperation, enhance survey data quality, and expand demographic diversity of the respondents even if the overall survey response rate is low.

14. The apparatus of claim 8, wherein the memory stores at least of:
further instructions for selecting from at least one of mail, telephonic, online or in-person and the language for the survey is selected depending on the pre-determined profile for the survey participant regardless of whether the participant self-identifies for at least one of preferred format, language or culture;
further instructions for allowing the survey participant self-identifies for at least one of preferred format, language or culture; or
further instructions for selecting an addressed-based household sampling method used in the survey to maximize coverage of the survey participants of one or more demographic groups and subgroups.

15. The apparatus of claim 8, wherein the memory stores further instructions for removing from the survey at least one of outdated ethnic labels, words, or adding additional survey formats to survey taker expectations or biases toward a target survey participant demographic.

16. The apparatus of claim 8, wherein the memory stores further instructions for selecting a rating scale that is commonly used by survey participants in a specific survey participant demographic.

17. The apparatus of claim 8, wherein the memory stores further instructions for maximizing survey participant responses for non-English speaking survey participation by at least one of: matching the language and culture of a survey taker to the language and culture of the survey participant, obtaining post-survey feedback from the survey participant about the language and culture of the survey taker, or identifying the everyday relevance of the translation used for the survey.

18. The apparatus of claim 8, wherein the memory stores further instructions for eliminating colors from mail, in-person, or online surveys that may be offensive to different cultural groups based on tradition or superstition.

19. The apparatus of claim 8, wherein the memory stores further instructions for checking the questionnaire for at least one of comprehension, ability to follow instructions, scale confusion, or offensive language.

20. The apparatus of claim 8, wherein the memory stores further instructions for sending survey to survey participants based on the target survey participant demographic and allowing more time for mailed survey responses to return that are not in English.
